(19) United States
(12) Patent Application Publication
(10) Pub. No.: US 2009/0153441 A1
(43) Pub. Date: Jun. 18, 2009

(54) Plasma Display Device

(75) Inventor: Masanori TAKEUCHI, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/180,569

(22) Filed: Jul. 28, 2008

(30) Foreign Application Priority Data
Dec. 14, 2007 (JP) 2007-323315

(51) Int. Cl. G09G 3/28

(52) U.S. Cl. 345/60

(57) ABSTRACT

A plasma display device is provided which includes: drive circuits which supply, to display electrodes, progressive scan pulses for performing display on display lines of a plasma display panel based on respective display data, or simultaneous scan pulses for performing display based on the same display data with one even-numbered display line and one odd-numbered display line vertically adjacent to each other of the plasma display panel taken as a set, in each sub-frame of a plurality of weighted sub-frames in one frame; a motion detection circuit which detects a motion of an image based on an image signal; and a sub-frame number decision circuit which decides the number of sub-frames in which the simultaneous scan pulses are supplied in the one frame, according to the motion of the image.

### CROSS-REFERENCE TO RELATED APPLICATIONS

This application is based upon and claims the benefit of priority from the prior Japanese Patent Application No. 2007-323315, filed on Dec. 14, 2007, the entire contents of which are incorporated herein by reference.

### BACKGROUND OF THE INVENTION

1. Field of the Invention

The present invention relates to a plasma display device.

2. Description of the Related Art

The plasma display device suffers from the moving image pseudo contour or moving image blurring in a fast motion because it performs gradation expression by the sub-frame method.

In Japanese Patent Application Laid-Open No. 2000-347616 discloses a display device characterized in that, in the display device in which pixels to be turned on and light emission brightness are controlled based on an input signal, display resolution information is limited according to setting to shorten time to control the lighting pixels to be turned on.

FIG. 15 is a diagram showing a display method of a display device in Japanese Patent Application Laid-Open No. 2000-347616. One field has a plurality of sub-fields SF1 to SF3. Each of the sub-fields has a reset period Tr, an address period Ta, and a sustain period Ts. The same data is simultaneously scanned in a specific sub-field SF3 with two liens vertically adjacent to each other in one field taken as one set to thereby shorten the address period Ta, and a sustain pulse is added or a sub-field is added in the spare time.

Besides, in Japanese Patent Application Laid-Open No. 2003-233346 discloses a method of driving a dot-matrix-type AC plasma display panel in an interlace method, the plasma display panel including: display electrodes which extend adjacently in the same direction and perform light emission operation of display cells; and partition walls separating the display cells to form display lines between all of the display electrodes characterized in that data for one line of an interlace signal is displayed on adjacent two lines, and display weight centers of the two lines are shifted between an odd field and an even field.

FIG. 16 is a diagram showing the method of driving the plasma display panel in Japanese Patent Application Laid-Open No. 2003-233346. The set of two adjacent lines is composed of lines shifted by one line between the odd-numbered field and the even-numbered field to enable prevention of a decrease in vertical resolution.

### SUMMARY OF THE INVENTION

It is an object of the present invention to provide a plasma display device capable of preventing the moving image pseudo contour and moving image blurring.

The plasma display device of the present invention includes: a plasma display panel in which one display line is composed of a display electrode pair composed of two display electrodes, and the display electrode pairs of even-numbered display lines and the display electrode pairs of odd-numbered display lines are alternately arranged; drive circuits which supply, to the display electrodes, progressive scan pulses for performing display on the display lines of the plasma display panel based on respective display data, or simultaneous scan pulses for performing display based on the same display data with one even-numbered display line and one odd-numbered display line vertically adjacent to each other of the plasma display panel taken as a set, in each sub-frame of a plurality of weighted sub-frames in one frame; a motion detection circuit which detects a motion of an image based on an image signal; and a sub-frame number decision circuit which decides the number of sub-frames in which the simultaneous scan pulses are supplied in the one frame, according to the motion of the image, wherein the drive circuits supply the progressive scan pulses or the simultaneous scan pulses to the display electrodes in each of the sub-frames according to the number of sub-frames, decided by the sub-frame number decision circuit, in which the simultaneous scan pulses are supplied.

By deciding the number of sub-frames in which the simultaneous scan pulses are supplied according to the motion of the image, the moving image pseudo contour and moving image blurring can be prevented.

### BRIEF DESCRIPTION OF THE DRAWINGS

FIG. 1 is a block diagram showing a configuration example of a plasma display device according to an embodiment of the present invention;

FIG. 2 is a view illustrating the line of sight during general moving image;

FIG. 3 is a view illustrating the line of sight during moving image according to this embodiment;

FIG. 4 is a view showing an example of sub-frames in one frame of a still image, an example of sub-frames in one frame of a slow-moving image, and an example of sub-frames in one frame of a fast-moving image;

FIG. 5 is a diagram showing an example of odd-numbered frames and even-numbered frames for progressive scan;

FIG. 6 is a diagram showing an example of odd-numbered frames and even-numbered frames for simultaneous scan;

FIG. 7 is a diagram showing a processing example of a motion amount determination circuit in FIG. 1;

FIG. 8 is a diagram showing another processing example of the motion amount determination circuit in FIG. 1;

FIG. 9 is a diagram showing a processing example of a simultaneous scan sub-frame number calculation processing circuit in FIG. 1;

FIG. 10 is a diagram showing a configuration example of a plasma display panel, a Y-electrode driver, an X-electrode driver, and an address driver;

FIG. 11 is an exploded perspective view showing a configuration example of the plasma display panel according to this embodiment;

FIG. 12 is a diagram illustrating an example of a method of driving the plasma display panel;

FIG. 13 is a diagram showing examples of drive waveforms of the progressive scan in the plasma display device according to this embodiment;

FIG. 14 is a diagram showing examples of drive waveforms of the simultaneous scan in the plasma display device according to this embodiment;

FIG. 15 is a diagram showing a display method of a display device in Japanese Patent Application Laid-Open No. 2000-347616; and

FIG. 16 is a diagram showing a method of driving a plasma display panel in Japanese Patent Application Laid-Open No. 2003-233346.

### DETAILED DESCRIPTION OF THE PREFERRED EMBODIMENTS

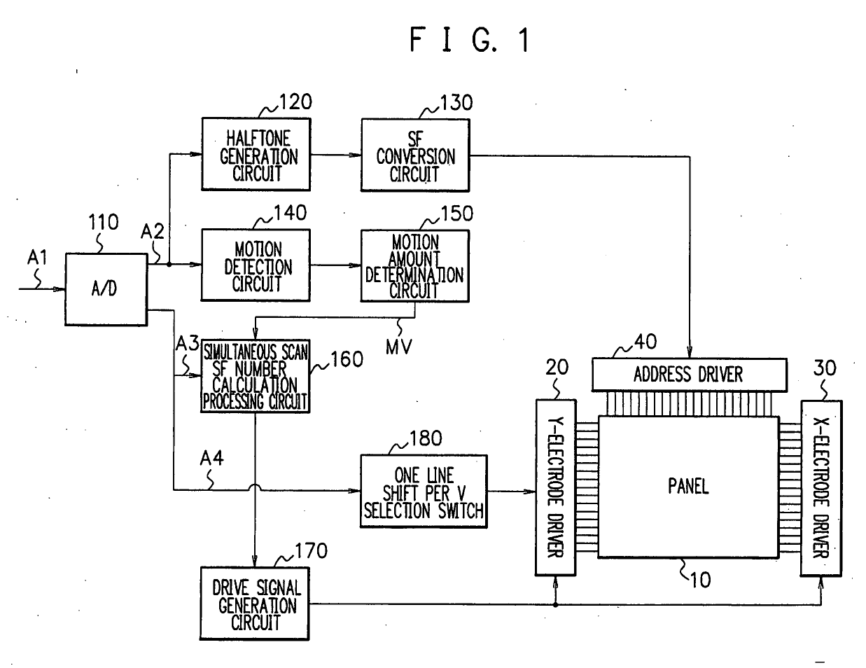

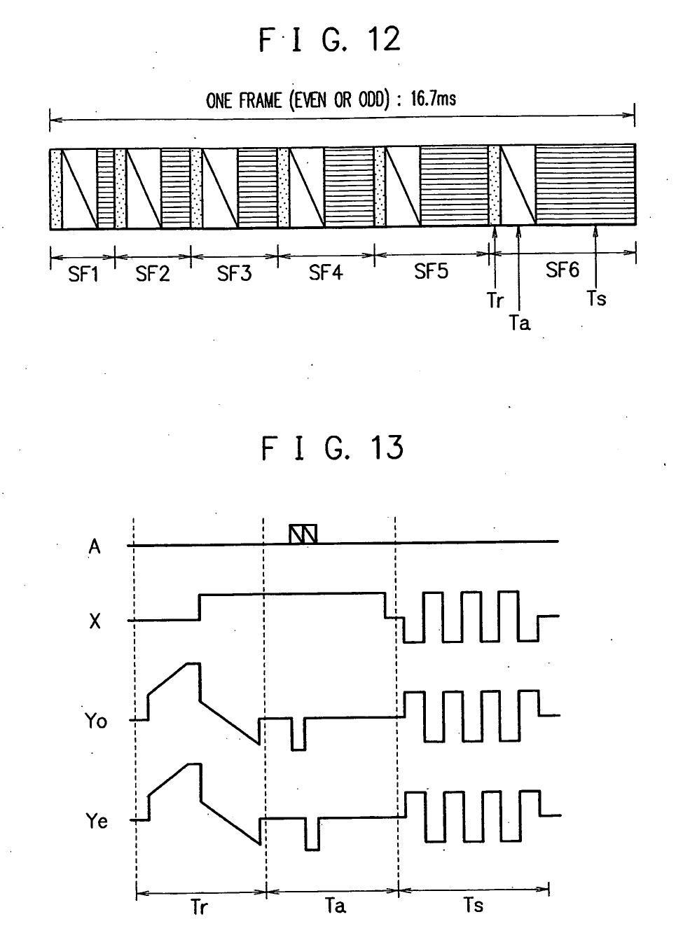

FIG. 1 is a block diagram showing a configuration example of a plasma display device according to an embodiment of the present invention. An A/D converter 110 converts an input analog image signal A1 to a digital image signal A2 and outputs a timing signal A3 and a parity signal A4. A halftone generation circuit 120 generates halftones by error diffusion and dither process in order to display the input image signal A2 in a lighting pattern of a limited number of bits. For example, the halftone generation circuit 120 performs error diffusion on a decimal part of the input image signal A2 having an integral part and the decimal part, and outputs an image signal composed of the integral part to a sub-frame (SF) conversion circuit 130. The sub-frame conversion circuit 130 converts the image signal outputted from the halftone generation circuit 120 to a lighting pattern for each sub-frame. The sub-frame will be described later with reference to FIG. 12. A motion detection circuit 140 detects moved pixels in the input image signal A2 as a motion. A motion amount determination circuit 150 decides a motion amount determination signal MV according to the number of moved pixels detected by the motion detection circuit 140 or the speed of the moved pixels. The motion amount determination signal MV takes a larger value as the number of moved pixels is larger or the speed of the motion of the moved pixels is higher. For a still image, the motion amount determination signal MV will be 0. A simultaneous scan sub-frame number calculation processing circuit 160 receives the timing signal A3 inputted thereinto and calculates the number of sub-frames for simultaneous scan (address selection) of the set of adjacent two lines according to the value of the motion amount determination signal MV. A drive signal generation circuit 170 generates a drive signal based on the number of sub-frames for simultaneous scan which has been calculated by the simultaneous scan sub-frame number calculation processing circuit 160. When the number of sub-frames for simultaneous scan which has been calculated by the simultaneous scan sub-frame number calculation processing circuit 160 is one or more, a selection switch 180 performs, according to the parity signal A4, processing of shifting lines one by one for the sub-frames for simultaneous scan and outputs it to a Y-electrode driver 20. The Y-electrode driver 20 supplies a voltage to Y electrodes of a plasma display panel 10 according to the drive signal generated by the drive signal generation circuit 170. An X-electrode driver 30 supplies a voltage to X electrodes of the plasma display panel 10 according to the drive signal generated by the drive signal generation circuit 170. An address driver 40 supplies a voltage to address electrodes of the plasma display panel 10 according to the lighting pattern obtained by conversion by the sub-frame conversion circuit 130. The plasma display panel 10 discharges and emits light according to the voltages to the address electrodes, the X electrodes, and the Y electrodes.

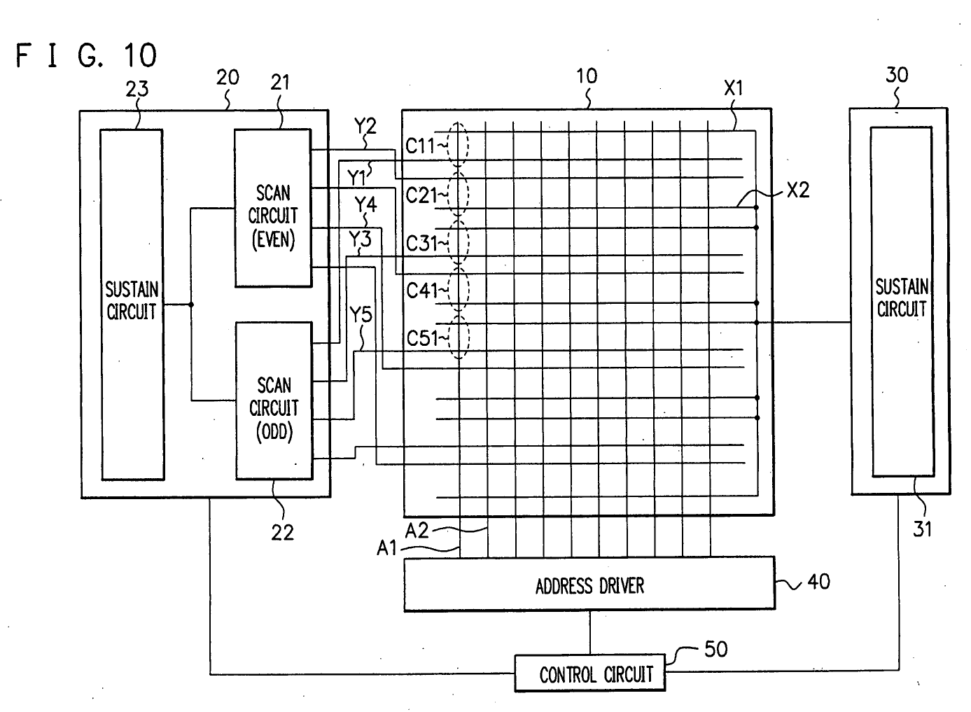

FIG. 10 is a view showing a configuration example of the plasma display panel 10, the Y-electrode driver 20, the X-electrode driver 30, and the address driver 40. A control circuit 50 corresponds to circuits other than the plasma display panel 10, the Y-electrode driver 20, the X-electrode driver 30, and the address driver 40 in FIG. 1.

The Y-electrode driver 20 is a circuit which drives Y electrodes (scan electrodes) Y1, Y2, and so on of display electrodes, and includes a scan circuit (even) 21, a scan circuit (odd) 22, and a sustain circuit 23. Hereinafter, each of the Y electrodes Y1, Y2, and so on or their generic name is referred to as a Y electrode Y1, i representing a suffix.

Each of the scan circuits 21 and 22 is composed of a circuit which generates scan pulses for sequentially scan lines and selecting a line to be displayed, and the sustain circuit 23 is composed of a circuit which generates sustain pulses (sustain discharge pulses) for repeating sustain discharge.

The scan circuits 21 and 22 and the sustain circuit 23 supply a predetermined voltage to the plurality of Y electrodes Yi. The scan circuit (even) 21 is provided corresponding to even-numbered Y electrodes Y2, Y4, and so on related to even-numbered display lines among display lines to supply the drive voltage to the Y electrodes Y2, Y4, and so on. The scan circuit (even) 21 operates to apply the scan pulses to the Y electrodes Y2, Y4, and so on in sequence during an address period and apply the sustain pulses from the sustain circuit 23 to the Y electrodes Y2, Y4, and so on in a sustain period.

Similarly, the scan circuit (odd) 22 is provided corresponding odd-numbered Y electrodes Y1, Y3, Y5, and so on related to odd-numbered display lines to supply the drive voltage to the Y electrodes Y1, Y3, Y5, and so on. The scan circuit (odd) 22 operates to apply the scan pulses to the Y electrodes Y1, Y3, and so on in sequence during the address period and apply the sustain pulses from the sustain circuit 23 to the Y electrodes Y1, Y3, and so on during the sustain period.

The scan circuit (even) 21 and the sustain circuit 23 are connected to each other, and the scan circuit (odd) 22 and the sustain circuit 23 are connected to each other.

The X-electrode driver 30 is a circuit which drives X electrodes (sustain electrodes) X1, X2, and so on of the display electrodes, and includes a sustain circuit 31. Hereinafter, each of the X electrodes X1, X2, and so on or their generic name is referred to as an X electrode Xi, i representing a suffix. The sustain circuit 31 is composed of a circuit which generates sustain pulses (sustain discharge pulses) for repeating sustain discharge, and supplies a predetermined voltage to the X electrodes Xi. The X electrodes Xi are commonly connected at their one ends to the X-electrode driver 30.

The address driver 40 is composed of a circuit which selects a line to be displayed and supplies a predetermined voltage to a plurality of address electrodes A1, A2, and so on. Hereinafter, each of the address electrodes A1, A2, and so on or their generic name is referred to as an address electrode Aj, j representing a suffix.

The control circuit 50 generates a control signal based on display data, clock signal, horizontal synchronization signal, vertical synchronization signal and so on inputted from an external part. The control circuit 50 supplies the generated control signal to the Y-electrode driver 20, the X-electrode driver 30, and the address driver 40 to control the drivers 20, 30 and 40.

In the plasma display panel 10, the Y electrodes Yi and the X electrodes Xi constituting display electrode pairs form rows extending in parallel in the horizontal direction, and the address electrodes Aj form columns extending in the vertical direction. The Y electrodes Yi and the X electrodes Xi are arranged in a predetermined arrangement pattern in the vertical direction and parallel to each other. The address electrodes Aj are arranged in a direction substantially vertical to the Y electrodes Yi and the X electrodes Xi. The Y electrodes Yi and the address electrodes Aj form a two-dimensional matrix with i rows and j columns.

In the plasma display device 10 in this embodiment here, a display electrode pair composed of two electrodes (a pair of the Y electrode Yi and the X electrode Xi) is placed for one display line so that adjacent display lines do not commonly use the same display electrode. More specifically, pairs of the Y electrodes Y (2p−1) and the X electrodes (2p−1) constitute odd-numbered display lines among the display lines and pairs of the Y electrodes Y (2p) and the X electrodes (2p) constitute even-numbered display lines where p is a natural number. For example, the pair of the Y electrode Y1 and the X electrode X1 constitutes a first display line, and the pair of the Y electrode Y2 and the X electrode X2 constitutes a second display line.

A cell Cij is formed of an intersection of the Y electrode Yi and the address electrode Aj, and the X electrode Xi adjacent corresponding to it. This cell Cij corresponds to a sub-pixel for red, green or blue, and those sub-pixels in three colors constitute one pixel. The panel 10 displays an image by turning-on of a plurality of pixels arranged in two dimensions. The scan circuits 21 and 22 in the Y-electrode driver 20 and the address driver 40 determine which cell to be turned on, and the sustain circuit 23 in the Y-electrode driver 20 and the sustain circuit 31 in the X-electrode driver 30 repeatedly perform discharge, thereby performing display operation.

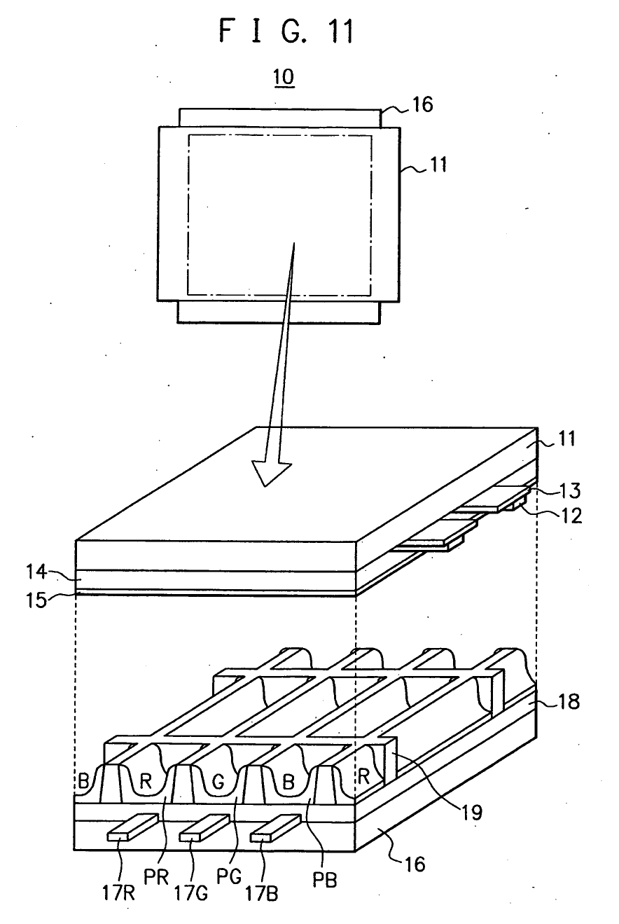

FIG. 11 is an exploded perspective view showing a configuration example of the plasma display panel 10 according to this embodiment.

On a front glass substrate 11, display electrodes (referred also to as sustain electrodes) composed of bus electrodes (metal electrodes) 12 and transparent electrodes 13 are formed. The display electrodes (12, 13) correspond to the Y electrode Yi and the X electrode Xi shown in FIG. 10. Over the display electrodes (12, 13), a dielectric layer 14 is provided, and a MgO (magnesium oxide) protective film 15 is further provided on the dielectric layer 14. In other words, the display electrodes (12, 13) arranged on the front glass substrate 11 are covered by the dielectric layer 14 and its surface is covered by the MgO protective film 15.

On a rear glass substrate 16 disposed opposed to the front glass substrate 11, address electrodes 17R, 17G and 17B are formed in a direction perpendicular to (to intersect with) the display electrodes (12, 13). The address electrodes 17R, 17G and 17B correspond to the address electrodes Aj shown in FIG. 10. On the address electrodes 17R, 17G and 17B, a dielectric layer 18 is provided.

On the dielectric layer 18, closed-type partition walls (ribs) 19 arranged in a grid pattern which partition the discharge space into cells, and phosphor layers PR, PG and PB which emit visible light in red (R), green (G), and bleu (B) for color display are formed. Ultraviolet rays generated by surface discharge between the paired display electrodes (12, 13) excite the phosphor layers PR, PG and PB to emit light in respective colors.

The partition walls 19 are composed of longitudinal partition walls (longitudinal ribs) formed in a direction in which the address electrodes 17R, 17G and 17B extend, and transverse partition walls (transverse ribs) formed in a direction in which the display electrodes (12, 13) extend. In short, the plasma display panel 10 according to this embodiment has a closed-type partition wall structure.

The phosphor layers PR, PG and PB are formed such that the phosphor layers PR which emit red light are formed above the address electrode 17R, the phosphor layers PG which emit green light are formed above the address electrode 17G, and the phosphor layers PB which emit blue light are formed above the address electrode 17B. In other words, the address electrodes 17R, 17G and 17B are arranged to correspond to the red, green and blue phosphor layers PR, PG and PB applied on inner surfaces of the partition walls 19 corresponding to the cells.

The plasma display panel 10 is constituted by sealing the front glass substrate 11 and the rear glass substrate 16 such that the protective film 15 and the partition walls 19 are in contact, and filling a discharge gas such as Ne—Xe gas therebetweeen (in the discharge space between the front glass substrate 11 and the rear glass substrate 16).

FIG. 12 is a diagram illustrating an example of a method of driving the plasma display panel 10. One frame (the odd numbered frame or the even numbered frame) is composed of a plurality of sub-frames (SFs). Though FIG. 12 shows a configuration in which one frame is composed of six sub-frames SF1, SF2, SF3, SF4, SF5 and SF6 for convenience of illustration, one frame usually has a configuration composed of 10 to 12 sub-frames.

Each of the sub-frames SF1 to SF6 is composed of a reset period Tr, an address period Ta, and a sustain period Ts. The wall charge state on the electrode is initialized in the reset period Tr, a cell to be turned on is selected by adjusting the wall charge state based on the display data in the address period Ta, and the cell corresponding to the display data is turned on (the cell selected according to the display data discharges to emit light) in the sustain period Ts. Selection of in which sub-frame SF1 to SF6 the cell is turned on can realize gradation expression.

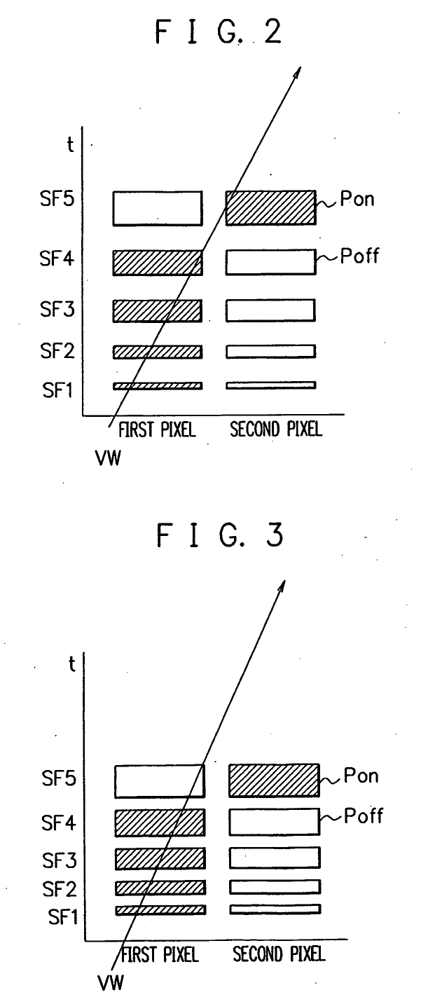

FIG. 2 is a view illustrating the motion of the line of sight during general moving image. The horizontal axis indicates the position of a pixel. The vertical axis indicates time t. With time t, the first sub-frame SF1, the second sub-frame SF2, the third sub-frame SF3, the fourth sub-frame SF4, and the fifth sub-frame SF5 are display in sequence. A turned-on region Pon represents a region which is turned on in the pixel in each sub-frame according to the display data “1.” A turned-off region Poff represents a region which is turned off in the pixel in each sub-frame according to the display data “0.”

The first pixel is in a gradation expressed such that (SF1, SF2, SF3, SF4, SF5)=(1, 1, 1, 1, 0). The second pixel is in a gradation expressed such that (SF1, SF2, SF3, SF4, SF5)=(0, 0, 0, 0, 1). The time duration of a rectangle in each sub-frame corresponds to a light emission period of the sustain period Ts. In this event, when the image moves, the line of sight VW crosses the sub-frames of the pixels, so that (SF1, SF2, SF3, SF4, SF5)=(1, 1, 1, 1, 1) is perceived on the retina of eyes of human beings, causing disorder of gradation due to sight of bright gradation. This brings about a problem of occurrence of a so-called moving image pseudo contour.

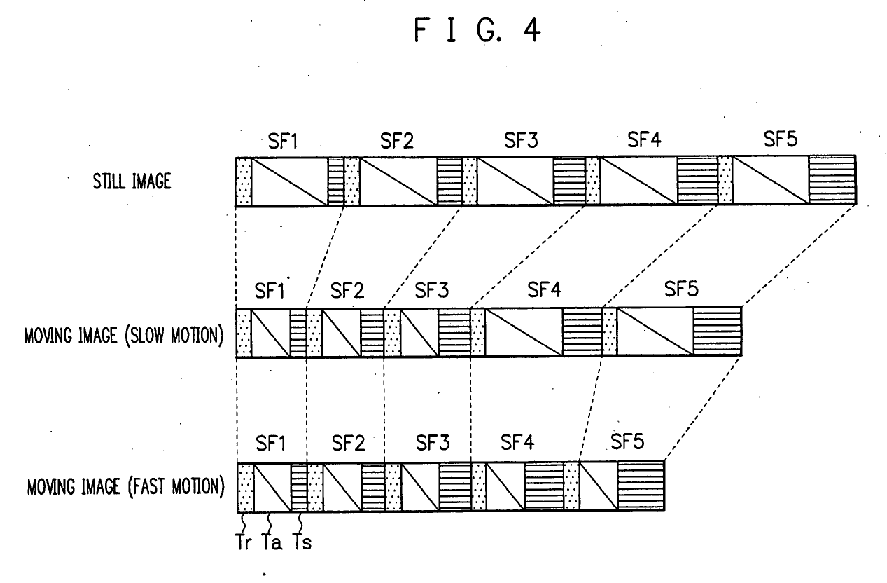

FIG. 3 is a view illustrating the motion of the line of sight during moving image according to this embodiment. The horizontal axis and the vertical axis are the same as those in FIG. 2. The time duration of a rectangle in each sub-frame corresponds to a light emission period of the sustain period Ts. In this case, the address period Ta in each sub-frame is shortened so that the interval between Ts in the sub-frames is decreased. When the moving image moves at the same speed as that in FIG. 2, the line of sight VW crosses the sub-frames of the pixels as in the drawing, so that (SF1, SF2, SF3, SF4, SF5)=(1, 1, 1, 1, 0) is perceived on the retina of eyes of human beings, causing no disorder of gradation (moving image pseudo contour). Hereinafter, the details of a method of shortening the sustain period Ts in each sub-frame will be described with reference to FIG. 4 to FIG. 6.

FIG. 4 is a view showing an example of sub-frames in one frame of the still image, an example of sub-frames in one frame of a slow-moving image, and an example of sub-frames in one frame of a fast-moving image. Each of the sub-frames SF1 to SF5 has the reset period Tr, the address period Ta, and the sustain period Ts.

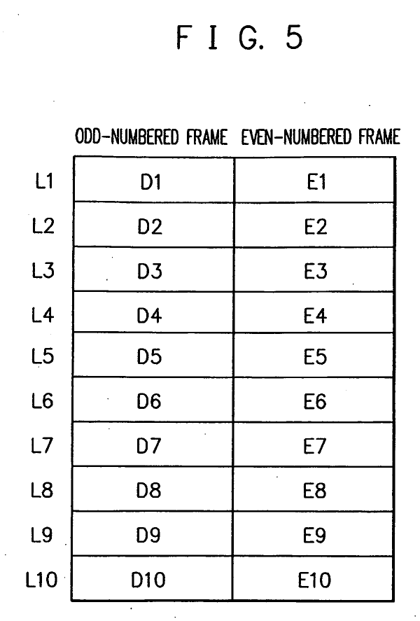

The frame of the still image at the upper tier in the drawing will be described first. In the still image, in favor of resolution of the still image, progressive scan for each line is performed in the address periods Ta in all of the sub-frames SF1 to SF5. As a result, the address period Ta is relatively long and each line displays independent data. The details for the above will be described later with reference to FIG. 5 and FIG. 13. Hereinafter, this scan method is referred to as a progressive scan.

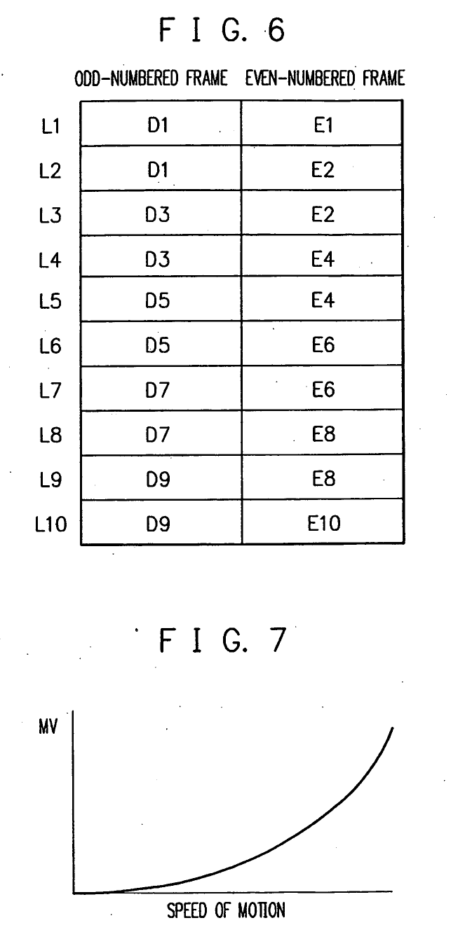

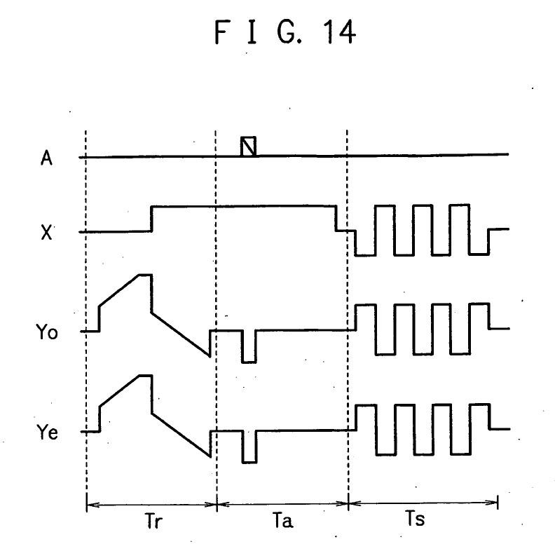

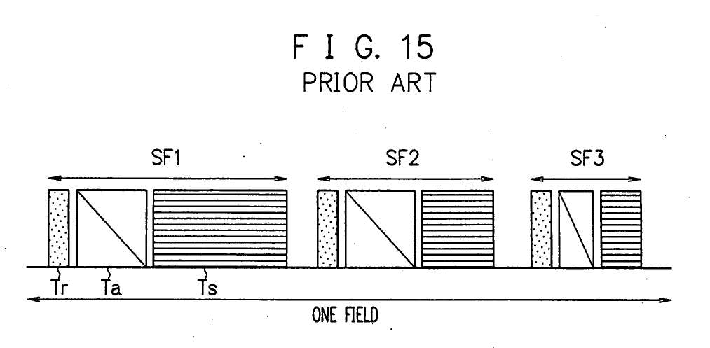

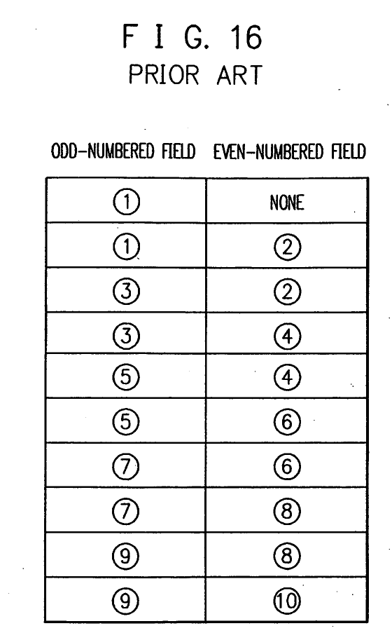

Next, the frame of the fast-moving image at the lower tier in the drawing will be described. In the fast-moving image, in favor of resolution of the moving image, simultaneous scan of the same data for every two adjacent lines is performed in the address periods Ta in all of the sub-frames SF1 to SF5. As a result, the address period Ta is relatively short (about half the address period Ta of the still image) and the adjacent two lines display the same data. Halving the address period Ta can prevent the moving image pseudo contour and moving image blurring, as shown in FIG. 3. In short, the address period Ta is halved to shift each sub-frame subsequent thereto forward in sequence. As a result, as shown in FIG. 3, the interval between the sustain periods of the sub-frames can be shortened to prevent the moving image pseudo contour and moving image blurring. The details for the above will be described later with reference to FIG. 6 and FIG. 14. Hereinafter, this scan method is referred to as a simultaneous scan.

Next, the frame of the slow-moving image at the middle tier in the drawing will be described. In the slow-moving image, simultaneous scan is performed in the address periods Ta in the sub-frames SF1 to SF3 so that the address period Ta is relatively short. The progressive scan is performed in the address periods Ta in the sub-frames SF4 and SF5 so that the address period Ta is relatively long.

As the motion of the moving image becomes faster, the number of sub-frames for simultaneous scan is increased. In this event, the number of sub-frames for simultaneous scan is increased starting from the sub-frame SF1 having a lower weight in sequence. The weight of the sub-frame is determined by the length of the sustain period Ts (the number of sustain pulses) in the sub-frame. From the sub-frame SF1 toward the sub-frame SF5, the sustain period Ts becomes longer in sequence to result in a higher weight. Selection whether to turn on each of the weighted sub-frames in the address period Ta allows gradation expression. The simultaneous scan leads to a decrease in vertical resolution as the still image. Therefore, the simultaneous scan can be performed from the sub-frame SF1 having a lower weight in sequence, thereby preventing the decrease in vertical resolution. The simultaneous scan sub-frame number calculation circuit 160 in FIG. 1 calculates the number of sub-frames for simultaneous scan as in the above manner based on the motion amount determination signal MV.

FIG. 5 is a diagram showing an example of odd numbered frames and even numbered frames for progressive scan. The progressive scan is performed in the sub-frames SF1 to SF5 of the still image and in the sub-frames SF4 and SF5 of the slow-moving image in FIG. 4. The plasma display panel 10 displays display data D1 to D10 on lines L1 to L10 in the odd numbered frames respectively, and displays display data E1 to E10 on the lines L1 to L10 in the even numbered frames respectively according to the input image signal. In other words, the plasma display panel 10 receives progressive display data inputted thereinto to perform progressive display.

FIG. 6 is a diagram showing an example of odd numbered frames and even numbered frames for simultaneous scan. The simultaneous scan is performed in the sub-frames SF1 to SF3 of the slow-moving image and in the sub-frames SF1 to SF5 of the fast-moving image in FIG. 4. Based on the input image signal (the progressive display data in FIG. 5), the plasma display panel 10 displays the same display data D1 on the lines L1 and L2, displays the same display data D3 on the lines L3 and L4, displays the same display data D5 on the lines L5 and L6, displays the same display data D7 on the lines L7 and L8, and displays the same display data D9 on the lines L9 and L10 in the odd numbered frames. The plasma display panel 10 displays the display data E1 on the line L1, displays the same display data E2 on the lines L2 and L3, displays the same display data E4 on the lines L4 and L5, displays the same display data E6 on the lines L6 and L7, displays the same display data E8 on the lines L8 and L9, and displays the display data E10 on the line L10 in the even numbered frames.

As described above, in each frame, the same display data is displayed with the vertically adjacent two lines as a set. This can halve the length of the address period Ta. Further, the set of two lines in odd numbered frame is shifted from the set of two lines in even numbered frame by one line. This can prevent deterioration in vertical resolution.

FIG. 7 is a diagram showing a processing example of the motion amount determination circuit 150 in FIG. 1. The motion amount determination circuit 150 outputs the motion amount determination signal MV according to the speed of the motion. The motion amount determination circuit 150 decides the motion amount determination signal MV according to the speed of the pixel having the largest motion among the pixels whose motions are detected. Note that when there are a predetermined number or more of pixels having large motions, the motion amount determination circuit 150 may determine the motion amount determination signal MV according to a representative value of their speeds in consideration of error detection by the motion detection circuit 140 and the mixture of noise into the image signal.

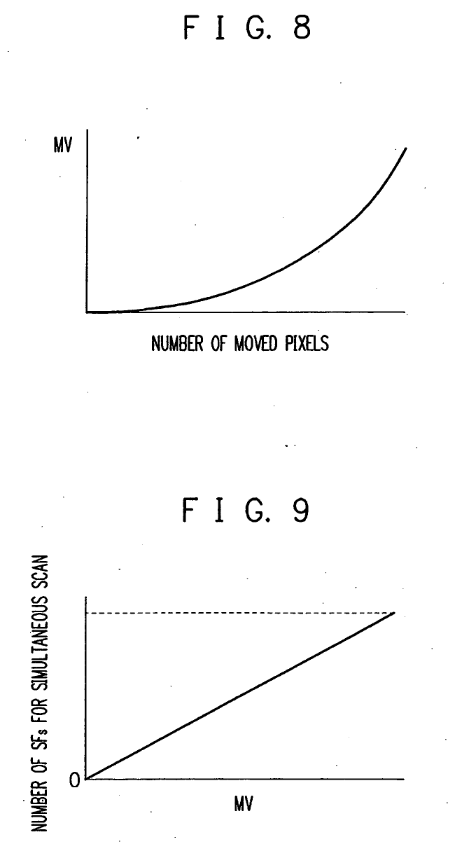

FIG. 8 is a diagram showing another processing example of the motion amount determination circuit 150 in FIG. 1. The motion amount determination circuit 150 outputs the motion amount determination signal MV according to the number of moved pixels. When there are a predetermined number or more of pixels whose motions are detected, the motion amount determination circuit 150 decides the motion amount determination signal MV according to the number.

Note the motion amount determination signal MV may be the total of values obtained by multiplying the motion amount determination signal shown in FIG. 7 and the motion amount determination signal shown in FIG. 8 with respective predetermined coefficients.

FIG. 9 is a diagram showing another processing example of the simultaneous scan sub-frame number calculation processing circuit 160 in FIG. 1. As shown in FIG. 4, the simultaneous scan sub-frame number calculation processing circuit 160 decides the number of sub-frames for simultaneous scan in one frame according to the motion amount determination signal MV. Specifically, the simultaneous scan sub-frame number calculation processing circuit 160 controls the number of sub-frames for simultaneous scan such that the number is larger as the motion amount determination signal MV becomes larger. For the still image at the upper tier in FIG. 4, the motion amount determination signal MV is 0 so that the number of sub-frames for simultaneous scan is 0. For the fast-moving image at the lower tier in FIG. 4, the motion amount determination signal MV takes the maximum value so that the number of sub-frames for simultaneous scan is the number of all sub-frames in one frame.

FIG. 13 is a diagram showing examples of drive waveforms of the progressive scan in the plasma display device according to this embodiment. The progressive scan is performed in the sub-frames SF1 to SF5 of the still image and the sub-frames SF4 and SF5 of the slow-moving image in FIG. 4. FIG. 13 shows examples of the drive waveforms relating to the X electrode Xi, the Y electrode Yi and the address electrode Aj in one sub-frame of the plurality of sub-frames constituting one frame. In FIG. 13, A show the voltage waveform to be applied to the address electrode Aj, X shows the voltage waveform to be applied to the X electrode Xi, Yo shows the voltage waveform to be applied the Y electrode Yi on the odd-numbered display line, and Ye shows the voltage waveform to be applied the Y electrode Yi on the even-numbered display line.

In the reset period Tr, initialization of the cells Cij is performed. In the reset period Tr, positive dull waves are concurrently applied to the Y electrodes Yi (Yo and Ye) to form wall charges, and subsequently negative dull waves are concurrently applied to them to adjust the wall charges of the cells Cij.

In the address period Ta, the progressive scan pulses are applied to the Y electrodes Yi, and the address pulses are applied to the address electrodes Aj according to data (by addressing), in correspondence with the scan pulses to thereby perform scan operation of selecting light emission or non-light emission of each cell Cij. In the address period Ta of the progressive scan, as shown in FIG. 5, the progressive scan pulses are supplied to all of the Y electrodes Yi to write different data into the cells on each Y electrode Yi.

In the sustain period Ts, sustain pulses with reverse phases are applied to the X electrodes Xi and the Y electrodes Yi (Yo and Ye) to perform sustain discharge between the X electrodes and the Y electrodes Yi (Yo and Ye) of the cells selected in the address period Ta, thereby emitting light. Note that in the sustain period Ts, the sustain pulses to be applied to the Y electrodes Yo and Ye are in the same phase.

FIG. 14 is a diagram showing examples of drive waveforms of the simultaneous scan in the plasma display device according to this embodiment. The simultaneous scan is performed the sub-frames SF1 to SF3 of the slow-moving image and in the sub-frames SF1 to SF5 of the fast-moving image in FIG. 4. Hereinafter the points of FIG. 14 different from FIG. 13 will be described.

In the address period Ta, the progressive scan pulses are applied to every two Y electrodes Yi as a set, and the address pulses are applied to the address electrodes Aj according to data (by addressing), in correspondence with the scan pulses to thereby perform scan operation of selecting light emission or non-light emission of each cell Cij. Specifically, in the address period Ta, as shown in FIG. 6, the simultaneous scan operation is performed, in the odd-numbered frame, for (2n+1)th lines being the odd-numbered display lines and (2n+2)th lines being the even-numbered display lines to thereby write the same data into the corresponding cells. In the even-numbered frame, the simultaneous scan operation is performed for the (2n+2)th lines being the even-numbered display lines and (2n+3)th lines being the odd-numbered display lines to thereby write the same data into the corresponding cells. The simultaneous scan allows selection of cells Cij on the same column on the odd-numbered display line and the even-numbered display line which constitute one set.

In other words, in this embodiment, the scan operation is performed for adjacent each one line of the odd-numbered display lines and the even-numbered display lines as a set to write the same data to the corresponding cells on the two lines. For example, in the odd-numbered frame, the data written into a cell C11 shown in FIG. 10 is written also into a cell C21, and the data written into a cell C31 is written also into a cell C41. Similarly, in the even-numbered frame, the data written into the cell C21 shown in FIG. 10 is written also into the cell C31, and the data written into the cell C41 is written also into the cell C51. This can halve the length of the address period Ta. Note that the simultaneous scan operation may be performed for the (2n+1)th lines and the (2n)th lines for the odd-numbered frame, and the simultaneous scan operation may be performed for the (2n+2)th lines and the (2n+1)th lines for the even-numbered frame.

The total number of sustain pulses for the even-numbered display line and the odd-numbered display line constituting one set is the same irrespective of the number of sub-frames, decided by the simultaneous scan sub-frame number calculation processing circuit 160, in which the simultaneous scan pulses are supplied. In other words, the number of sustain pulses in the sustain period Ts for the progressive scan in FIG. 13 is the same as the number of sustain pulses in the sustain period Ts for the simultaneous scan in FIG. 14. Note that they need not to be completely identical.

In the sustain period Ts, sustain pulses with reverse phases are applied to the X electrodes Xi and the Y electrodes Yi (Yo and Ye) to perform sustain discharge between the X electrodes and the Y electrodes Yi (Yo and Ye) of the cells selected in the address period Ta, thereby emitting light.

For the simultaneous scan, the display operation is performed simultaneously with two lines as a set. Assuming that the two lines forming one set are regarded as one line here, the display is performed with display line positions shifted between the odd-numbered frame and the even-numbered frame. This allows prevention of deterioration in vertical resolution.

As described above, according to this embodiment, the same data is simultaneously scanned in a specific sub-frame with vertically adjacent two lines in one frame of the panel 10 in the progressive display taken as one set. Upon detection of motion in the input image, the number of sub-frames for simultaneous scan is increased starting from the sub-frame having a lower weight without change in brightness to thereby shorten the address period Ta for prevention of the moving image pseudo contour and moving image blurring.

The plasma display device of this embodiment includes: a plasma display panel 10 in which one display line is composed of a display electrode pair composed of two display electrodes (X electrode and Y electrode), and the display electrode pairs of even-numbered display lines EL and the display electrode pairs of odd-numbered display lines OL are alternately arranged; drive circuits (drivers) 20 and 30 which supply, to the display electrodes, progressive scan pulses for performing display on the display lines of the plasma display panel 10 based on respective display data, or simultaneous scan pulses for performing display based on the same display data with one even-numbered display line EL and one odd-numbered display line OL vertically adjacent to each other of the plasma display panel 10 taken as a set, in each sub-frame of a plurality of weighted sub-frames in one frame; a motion detection circuit 140 which detects a motion of an image based on an image signal A2; and a sub-frame number decision circuit (the simultaneous scan sub-frame number calculation processing circuit) 160 which decides the number of sub-frames in which the simultaneous scan pulses are supplied in the one frame according to the motion of the image. The drive circuits 20 and 30 supply the progressive scan pulses or the simultaneous scan pulses to the display electrodes in each of the sub-frames according to the number of sub-frames, decided by the sub-frame number decision circuit 160, in which the simultaneous scan pulses are supplied.

As shown in FIG. 4, the sub-frame number decision circuit 160 makes the decision such that the number of sub-frames in which the simultaneous scan pulses are supplied in the one frame is larger for a moving image than that for a still image.

Further, as shown in FIG. 7 and FIG. 9, the sub-frame number decision circuit 160 makes the decision such that the number of sub-frames in which the simultaneous scan pulses are supplied in the one frame becomes larger as the motion of the image becomes faster.

Further, as shown in FIG. 8 and FIG. 9, the sub-frame number decision circuit 160 makes the decision such that the number of sub-frames in which the simultaneous scan pulses are supplied in the one frame becomes larger as the number of moved pixels in the image increases.

Further, as shown in FIG. 6, the set constituting the one even-numbered display line and the one odd-numbered display line differs in combination between the odd-numbered frame and the even-numbered frame.

Further, as shown in FIG. 13 and FIG. 14, the total number of sustain pulses for the even-numbered display line and the odd-numbered display line constituting the one set is substantially the same irrespective of the number of sub-frames, decided by the sub-frame number decision circuit 160, in which the simultaneous scan pulses are supplied. In other words, the number of sustain pulses in the sustain period Ts for the progressive scan in FIG. 13 is substantially the same as the number of sustain pulses in the sustain period Ts for the simultaneous scan in FIG. 14.

Further, as shown in FIG. 4, the sub-frame in which the simultaneous scan pulses are supplied is made shorter than the sub-frame in which the progressive scan pulses are supplied. The shortened sub-frame for the simultaneous scan pulse is disposed shifted forward.

Further, as shown in FIG. 4, the drive circuits 20 and 30 supply the simultaneous scan pulses while assigning the sub-frame in which the simultaneous scan pulses are supplied in the one frame in sequence from the sub-frame SF1 having a lower weight in the one frame according to the number of sub-frames, decided by the sub-frame number decision circuit 160, in which the simultaneous scan pulses are supplied.

Further, as shown in FIG. 4, the sub-frame number decision circuit 160 makes the decision to supply the progressive scan pulses in all of the sub-frames in the one frame for a still image.

Further, as shown in FIG. 14, the drive circuits 20 and 30 select display cells on the same column on the even-numbered display line EL and the odd-numbered display line OL constituting the one set by supplying the simultaneous scan pulses in an address period Ta to select a display cell Cij to be turned on among a plurality of display cells Cij constituting the display lines.

As described above, according to this embodiment, the number of sub-frames in which the simultaneous scan pulses are supplied according to the motion of an image, thereby allowing prevention of the moving image pseudo contour and moving image blurring.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device comprising:
a plasma display panel in which one display line is composed of a display electrode pair composed of two display electrodes, and the display electrode pairs of even-numbered display lines and the display electrode pairs of odd-numbered display lines are alternately arranged;
drive circuits which supply, to the display electrodes, progressive scan pulses for performing display on the display lines of said plasma display panel based on respective display data, or simultaneous scan pulses for performing display based on the same display data with one even-numbered display line and one odd-numbered display line vertically adjacent to each other of said plasma display panel taken as a set, in each sub-frame of a plurality of weighted sub-frames in one frame;
a motion detection circuit which detects a motion of an image based on an image signal; and
a sub-frame number decision circuit which decides the number of sub-frames in which the simultaneous scan pulses are supplied in the one frame, according to the motion of the image,
wherein said drive circuits supply the progressive scan pulses or the simultaneous scan pulses to the display electrodes in each of the sub-frames according to the number of sub-frames, decided by said sub-frame number decision circuit, in which the simultaneous scan pulses are supplied.

2. The plasma display device according to claim 1,
wherein said sub-frame number decision circuit makes the decision such that the number of sub-frames in which the simultaneous scan pulses are supplied in the one frame is larger for a moving image than that for a still image.

3. The plasma display device according to claim 1,
wherein said sub-frame number decision circuit makes the decision such that the number of sub-frames in which the simultaneous scan pulses are supplied in the one frame becomes larger as the motion of the image becomes faster.

4. The plasma display device according to claim 1,
wherein said sub-frame number decision circuit makes the decision such that the number of sub-frames in which the simultaneous scan pulses are supplied in the one frame becomes larger as the number of moved pixels in the image increases.

5. The plasma display device according to claim 1,
wherein the set constituting the one even-numbered display line and the one odd-numbered display line differs in combination between an odd-numbered frame and an even-numbered frame.

6. The plasma display device according to claim 1,
wherein the total number of sustain pulses for the even-numbered display line and the odd-numbered display line constituting the one set is substantially the same irrespective of the number of sub-frames, decided by said sub-frame number decision circuit, in which the simultaneous scan pulses are supplied.

7. The plasma display device according to claim 1,
wherein the sub-frame in which the simultaneous scan pulses are supplied is made shorter than the sub-frame in which the progressive scan pulses are supplied, and
wherein the shortened sub-frame for the simultaneous scan pulse is disposed shifted forward.

8. The plasma display device according to claim 1,
wherein said drive circuits supply the simultaneous scan pulses while assigning the sub-frame in which the simultaneous scan pulses are supplied in the one frame in sequence from the sub-frame having a lower weight in the one frame according to the number of sub-frames, decided by said sub-frame number decision circuit, in which the simultaneous scan pulses are supplied.

9. The plasma display device according to claim 1,
wherein said sub-frame number decision circuit makes the decision to supply the progressive scan pulses in all of the sub-frames in the one frame for a still image.

10. The plasma display device according to claim 1,
wherein said drive circuits select display cells on the same column on the even-numbered display line and the odd-numbered display line constituting the one set by supplying the simultaneous scan pulses in an address period to select a display cell to be turned on among a plurality of display cells constituting the display lines.

11. The plasma display device according to claim 2,
wherein said sub-frame number decision circuit makes the decision such that the number of sub-frames in which the simultaneous scan pulses are supplied in the one frame becomes larger as the motion of the image becomes faster.

12. The plasma display device according to claim 11,
wherein the set constituting the one even-numbered display line and the one odd-numbered display line differs in combination between an odd-numbered frame and an even-numbered frame.

13. The plasma display device according to claim 12,
wherein the total number of sustain pulses for the even-numbered display line and the odd-numbered display line constituting the one set is substantially the same irrespective of the number of sub-frames, decided by said sub-frame number decision circuit, in which the simultaneous scan pulses are supplied.

14. The plasma display device according to claim 13,
wherein the sub-frame in which the simultaneous scan pulses are supplied is made shorter than the sub-frame in which the progressive scan pulses are supplied, and
wherein the shortened sub-frame for the simultaneous scan pulse is disposed shifted forward.

15. The plasma display device according to claim 14,
wherein said drive circuits supply the simultaneous scan pulses while assigning the sub-frame in which the simultaneous scan pulses are supplied in the one frame in sequence from the sub-frame having a lower weight in the one frame according to the number of sub-frames, decided by said sub-frame number decision circuit, in which the simultaneous scan pulses are supplied.

16. The plasma display device according to claim 15,
wherein said sub-frame number decision circuit makes the decision to supply the progressive scan pulses in all of the sub-frames in the one frame for a still image.

17. The plasma display device according to claim 16,
wherein said drive circuits select display cells on the same column on the even-numbered display line and the odd-numbered display line constituting the one set by supplying the simultaneous scan pulses in an address period to select a display cell to be turned on among a plurality of display cells constituting the display lines.
